(19) United States
(12) Patent Application Publication
(10) Pub. No.: US 2025/0179938 A1
(43) Pub. Date: Jun. 5, 2025

(54) COUPLED ASSEMBLY

(71) Applicant: L'Air Liquide, Societe Anonyme pour l'Etude et l’Exploitation des Procedes Georges Claude, Paris (FR)

(72) Inventor: Fabien DURAND, Sassenage (FR)

(73) Assignee: L'Air Liquide, Societe Anonyme pour l'Etude et l’Exploitation des Procedes Georges Claude, Paris (FR)

(21) Appl. No.: 18/842,135

(22) PCT Filed: Feb. 15, 2023
(86) PCT No.: PCT/EP2023/053745

§ 371 Date: Aug. 28, 2024

(30) Foreign Application Priority Data
Feb. 28, 2022 (FR) FR 2201711

(51) Int. Cl. F01D 25/28; F01D 25/24

(52) U.S. Cl. CPC F01D 25/285; F01D 25/243; F05D 2230/644; F05D 2230/70; F05D 2230/72

(57) ABSTRACT

The invention relates to an assembly having a machine that has of a first element coupled to a second element, the machine being connected to a chassis, the chassis also having a guide interface for guiding the second element in translation relative to the first element along a decoupling direction, the guide interface having a first guide track and a second guide track.

### CROSS-REFERENCE TO RELATED APPLICATIONS

This application is a § 371 of International PCT Application PCT/EP2023/053745, filed Feb. 15, 2023, which claims §119(a) foreign priority to French patent application FR 2201711, filed Feb. 28, 2022.

### BACKGROUND

The present invention relates to the field of industrial machines and more particularly to machines comprising a motor element coupled to a driven element.

### FIELD OF THE INVENTION

An assembly comprising a turbo-compressor consisting of a motor-compressor to which is coupled a turbine which is connected to a network of pipework is known. The turbo-compressor is generally bolted to a receiving frame which locks the coupling of the motor-compressor to the turbine as well as providing direct connections between the motor-compressor and the turbine. The frame also allows the turbo-compressor to be connected to a surface of a support. The coupling of the turbine to the motor-compressor requires precision in the alignment of these two elements with respect to each other which is between one tenth of a millimeter and one millimeter. Assembly with such precision is very difficult, particularly when the elements to be assembled weigh several tons. In addition, on-site maintenance operations that require uncoupling of the two elements in a difficult and/or unstable mechanical environment, such as on a ship or an offshore platform, are complex and risky for the elements.

### OBJECT OF THE INVENTION

The object of the invention is notably to facilitate the operations of assembling and dismantling a machine comprising two coupled elements.

### SUMMARY OF THE INVENTION

To this end, the invention provides an assembly comprising a machine consisting of a first element coupled to a second element, the machine being connected to a chassis which comprises a guide interface for guiding the second element in translation relative to the first element in a direction of uncoupling, the guide interface comprising a first guide track and a second guide track.

The guide interface and notably the two guide tracks is (are) configured to support the second element and allow it to move relative to the first element in the direction of uncoupling and in a direction normal to the latter direction.

Thus, the assembly/dismantling of the second element of the machine is facilitated by the translational guidance interface and the use of lifting gear is limited.

The stability of the second element during the assembly and dismantling operations is improved when a first straight line normal to the first track considered in a first plane orthogonal to the direction of uncoupling forms, with the support, a first angle comprised between ten and eighty degrees, preferably forty-five degrees and/or when a second straight line normal to the second track considered in the first plane forms, with the support, a second angle comprised between ten and eighty degrees, preferably forty-five degrees.

Advantageously, a first straight line normal to the first track and a second straight line normal to the second track considered in a first plane orthogonal to the direction of uncoupling intersect at a first point. The forces for translating the second element are reduced when a third angle, formed by the first straight line and the second straight line, is comprised between twenty and one hundred and sixty degrees, preferably ninety degrees, or even when the first point belongs to a third straight line substantially parallel to the direction of uncoupling and which passes through a center of gravity of the second element.

Advantageously, the guide interface comprises at least one first roller and/or at least one first slide pad.

Preferably, the first point is located on an axis of rotation of a rotating shaft of the first element or of the second element.

Also advantageously, the guide interface comprises an adjusting mechanism for adjusting the position of the first roller and/or of the first slide pad relative to the second assembly or to the chassis and/or a third adjusting mechanism for adjusting the position of the first track and/or of the second track relative to the chassis. An economical embodiment is obtained when the first roller is an eccentric roller.

The compactness of the assembly is improved when the guide interface is removably connected to the chassis or to the second element.

Preferably, with the machine being a rotating machine, the first element is a driven element, such as at least one turbine wheel or at least one compressor wheel and the second element is a driving element such as a motor provided, if appropriate, with at least one compressor wheel or a turbine. That is to say, that the first element is assembled at one end of an axle of a motor the other end of the axle of which may comprise at least one other wheel. It should be noted that it is also possible to provide more than one wheel at one end and/or at the other end of the shaft of the motor, for example two compressor wheels and a turbine wheel at one end of the shaft (first element) and, at the other end, a drive motor (second element). Alternatively, a turbine may have the function of a driving element and drive an alternator and/or a compressor.

Other features and advantages of the invention will become apparent on reading the following description of one particular and non-limiting embodiment of the invention.

### BRIEF DESCRIPTION OF THE FIGURES

Reference will be made to the appended drawings, in which:

FIG. 1 is a schematic front view of an assembly according to a first embodiment of the invention;

FIG. 2 is a schematic side view of the assembly of FIG. 1;

FIG. 3 is a schematic top view of the assembly of FIG. 1;

FIG. 4 is a partial schematic view of a detail of the assembly of FIG. 2;

FIG. 5 is a schematic side view of an assembly according to a second embodiment of the invention;

FIG. 6 is a schematic top view of the assembly of FIG. 5;

FIG. 7 is a partial schematic view of a detail of the assembly of FIG. 5.

### DETAILED DESCRIPTION OF THE INVENTION

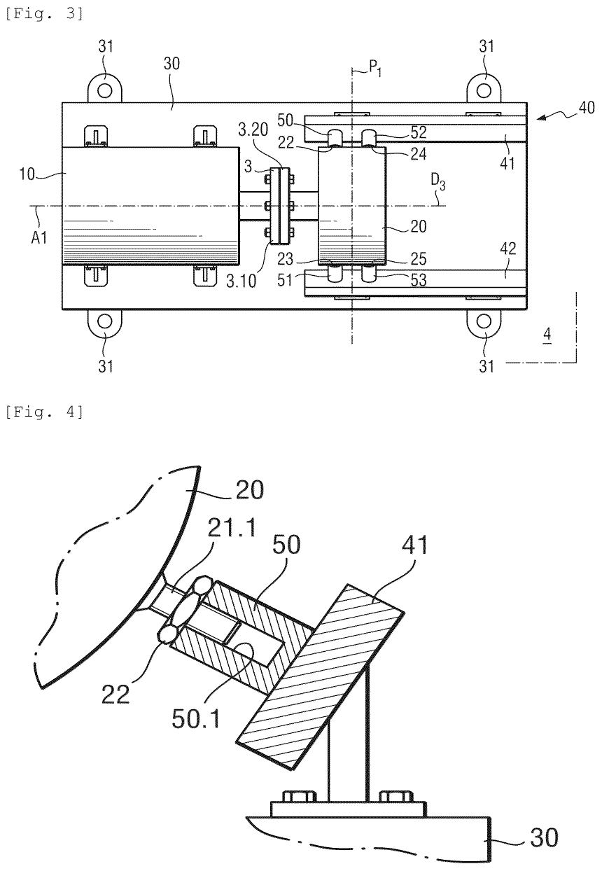

With reference to FIGS. 1 to 3, the assembly according to the invention, and designated overall as 1, comprises a turbo-compressor 2 comprising a turbine 10, of which a first shaft 11 is coupled to a second shaft 21 of a motor-compressor 20 by means of a flange 3. The flange 3 comprises a first half-flange 3.10 secured to the first shaft 11 and a second half-flange 3.20 secured to the second shaft 21. The first shaft 11 and the second shaft 21 are mounted to rotate about a first axis A1. The turbine 10 is bolted to a chassis 30 provided with lugs 31 for fixing to a deck 4, shown horizontally here, of a ship (not shown). The assembly 1 also comprises a guide interface 40 for guiding the motor-compressor 20 in translation in a direction of uncoupling O1. The interface 40 comprises a first track 41 and a second track 42 which are bolted to the chassis 30. The track 41 is, here, a plane track produced using a first chromium-plated flat metal bar 41.1. The track 42 is, here, a plane track produced using a second chromium-plated flat metal bar 42.1.

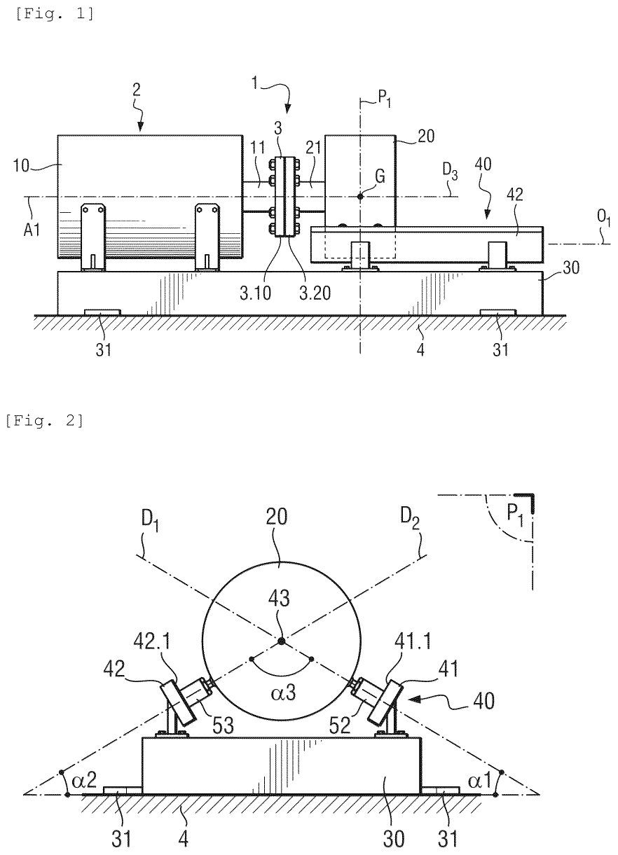

As can be seen in FIG. 2, a first straight line D1 normal to the track 41, and considered in a first plane P1 orthogonal to the direction O1, forms, with the deck 4, a first angle α1 equal to forty-five degrees. A second straight line D2 normal to the second track, and considered in the plane P1, forms, with the deck 4, a second angle α2 equal to forty-five degrees. The straight line D1 and the straight line D2 intersect at a first point 43 and form a third angle α3, here equal to ninety degrees. The first point 43 belongs, here, to a third straight line D3 parallel to the direction O1 and which passes through a center of gravity G of the motor-compressor 20. The third straight line D3 coincides, here, with the first axis A1.

The interface 40 also comprises a first slide pad 50, a second slide pad 51, a third slide pad 52 and a fourth slide pad 53, for example made of polytetrafluoroethylene. The pads 50 and 52 come to bear on the track 41 and the pads 51 and 53 come to bear on the track 42.

As can be seen in FIG. 4, the pad 50 preferably comprises a central housing 50.1 for receiving a threaded rod 21.1 welded to the motor-compressor 20. A first nut 22 mounted on the rod 21.1 between the motor-compressor 20 and the pad 50 makes it possible to adjust the position of the pad 50 relative to the motor-compressor 20.

The pads 51 to 53 are identical to the pad 50 and are mounted identically on the motor-compressor 20. Thus, the pad 51 is adjustable in position by means of a second nut 23, the pad 52 is adjustable in position by means of a third nut 24 and the pad 53 is adjustable in position by means of a fourth nut 25.

The assembling of the motor-compressor 20 of the assembly 1 will now be described. The motor-compressor 20 is lifted by means of a spreader bar and positioned relative to the chassis 30 in such a way that at least two of the pads 50 to 53 are in contact with the first track 41 and/or the second tracks 42. Once the motor-compressor 20 has been detached from the spreader bar, it is moved in the direction A1 until the second half-flange 3.20 comes into contact with the first half-flange 3.10. The position of the motor-compressor 20 relative to the turbine 10 is then adjusted by means of the nuts 22 and 24 and by means of the nuts 23 and 25 so that the half-flange 10 and the second half-flange 20 are in the assembly position. The half-flanges 10 and 20 are then bolted together. The invention thus makes it possible to adjust the position of the axis of the motor-compressor 20 with respect to the turbine 10 by acting in sequence, preferably first on the nuts secured to a first track 41, and then on the nuts secured to the second track 42.

The removal/refitting of the motor-compressor 20 of the assembly 1 will now be described.

When a maintenance operation (diagnosis or replacement) has to be carried out on the motor-compressor 20, the tracks 41 and 42 are mounted on the chassis 30 (when the tracks are not integral with the chassis). The nuts 22 to 25 are then acted upon so that most of the weight of the motor-compressor 20 is taken up by the tracks 41 and 42. The flange 3 is then dismantled. The motor-compressor 20 is then detached from the turbine 10 by causing it to translate in the direction O1 manually or with the aid of suitable lifting devices such as winches or hoists. It is then possible to work on the motor-compressor 20 resting on the tracks 41 and 42 or to remove it. The refitting operations are carried out in the reverse order to those described above. Fine adjustment of the position of the pads 50 to 53 can be made at any time by acting on the nuts 22 to 25 if necessary. Once the motor-compressor 20 has been coupled to the turbine 10, it is possible, if the flange 3 has been dimensioned such that it can also mechanically hold the motor-compressor 20 relative to the turbine 10, to proceed with the removal of the tracks 41 and 42, or even of the pads 50 to 53.

Thus, the assembly can be assembled and/or dismantled more quickly and with greater precision, reducing the risk of damaging the machines and simplifying the post-installation operations.

In particular, when the third angle α3 is substantially equal to ninety degrees, the invention makes it possible to adjust the assembly in a single operation, the adjustment of the displacement elements (pads and/or rollers) associated with the first guide track being entirely separate from the adjustment of the displacement elements (pads and/or rollers) associated with the second guide track.

Elements that are identical or similar to those described above have the same numerical reference sign in the following description of a second embodiment of the invention.

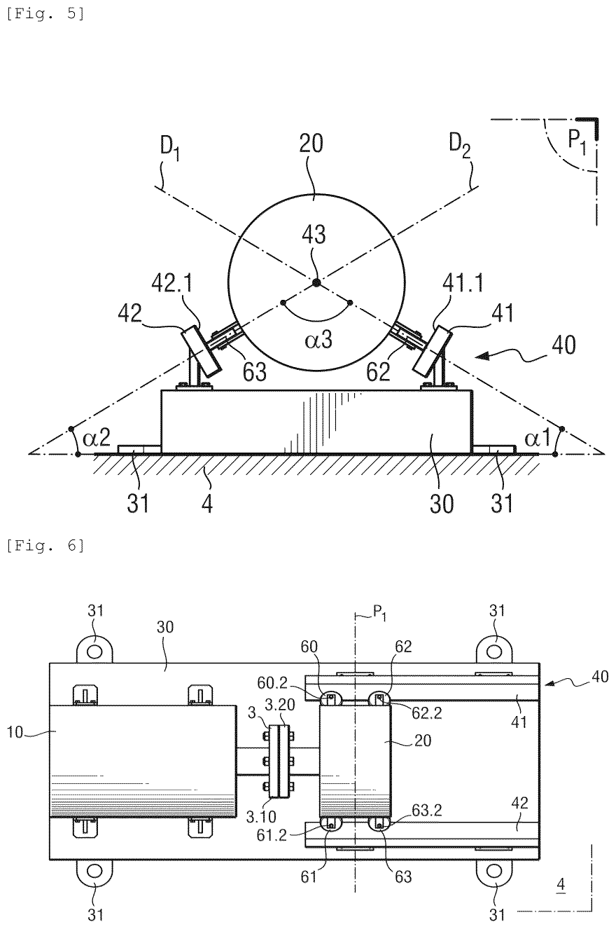

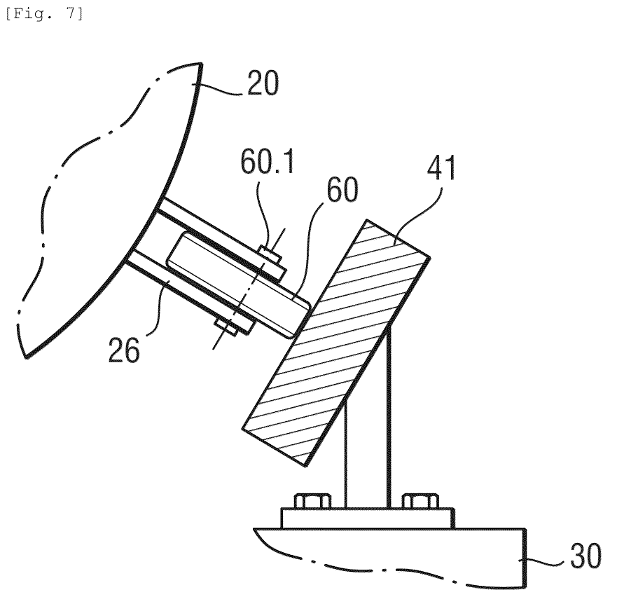

With reference to FIGS. 5 and 6, the interface 40 here comprises, in place of the pads 50 to 53, a first roller 60, a second roller 61, a third roller 62 and a fourth roller 63. The rollers 60 and 62 come to bear on the track 41 and the rollers 61 and 63 come to bear on the track 42.

As can be seen in FIG. 7, the roller 60 is a roller with a first eccentric 60.1 of known type connected to the motor-compressor 20 by two welded lugs 26 which cooperate with the first adjusting crank 60.2 of the eccentric 60.1. Thus, by acting on the crank 60.2, it is possible to adjust the position of the roller 60 relative to the motor-compressor 20.

The rollers 61 to 63 are identical to the roller 60 and mounted identically on the motor-compressor 20. Thus, the roller 61 is adjustable in position by means of a second crank 61.2, the roller 62 is adjustable in position by means of a third crank 62.2 and the roller 63 is adjustable in position by means of a fourth crank 63.3.

Of course, the invention is not limited to the embodiment described but encompasses any variant that falls within the scope of the invention as defined by the claims.

In particular:

although here the assembly comprises a turbo-compressor composed of a motor-compressor and of a turbine, the invention also applies to other types of machines comprising a driven first element coupled to a driving second element such as, for example, a motor coupled to a reduction gear, a turbine coupled to an alternator, a turbine coupled to a compressor, a turbine coupled to a motor, a turbine coupled to a motor-compressor, a motor coupled to a compressor, a motor coupled to a turbine, a compressor coupled to a motor, a motor coupled to a compressor;

although here the turbine is bolted to the chassis, the invention also applies to other means of connecting the machine to the chassis such as, for example, a connection of the two elements by bolting, screwing, welding, clip-fastening or the like;

although here the tracks are connected to the chassis by bolting, the invention also applies to other methods of connecting the guide means removably to the chassis, such as, for example, screwing or pinning;

although here the tracks are mounted removably relative to the chassis, the invention also applies to guide means permanently connected to the chassis, such as, for example, connected by welding;

although here the sliding or rolling tracks are borne by the chassis and the rollers or pads are borne by the second element, the invention also applies to a kinematic inversion of the guide means, namely tracks borne, removably or otherwise, by the second element, and rollers or pads borne by the chassis;

although here the first angle and the second angle are both equal to forty-five degrees, the invention also applies to a first angle and a second angle of identical or different values and the values of which may be comprised between ten and eighty degrees;

although here the third angle is equal to ninety degrees, the invention also applies to other values of the third angle which may be between twenty and one hundred and sixty degrees;

although here the second element comprises four rollers or four pads cooperating with two tracks, the invention also applies to a translational guidance interface comprising a different number of sliding or rolling elements, such as, for example, a single sliding or rolling element per track, more than two tracks, a single track, a roller track cooperating with one or more rollers and a sliding track cooperating with one or more pads;

although here the pads are threaded onto a threaded rod integral with the second element, the invention also applies to other means for adjusting the position of the pads relative to the second assembly or to the chassis, such as, for example, a threaded rod integral with the pad and a nut attached to the rotating machine, or a pneumatic jack;

although here the roller is an eccentric roller, the invention also applies to other means for adjusting the position of the roller relative to the second element, such as, for example, a roller support mounted on a threaded rod or on a pneumatic jack;

although plane rolling or sliding tracks have been described, the invention also applies to other types of guide tracks such as, for example, flat, convex or concave tracks, tracks having a guide profile of the convex or concave rail type;

although here the chassis is fixed by means of lugs on a ship's deck, the invention also applies to other means of connection to a support such as, for example, screwing, welding or clamping, and the support may be horizontal, vertical or oriented in any manner whatsoever;

although here the pads are made of polytetrafluoroethylene, they could be made of other plastics, bronze, stainless steel or other suitable materials.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-16. (canceled)

17. An assembly comprising a machine comprising a first element coupled to a second element, the machine being connected to a chassis which comprises a guide interface for guiding the second element in translation relative to the first element in a direction of uncoupling, the guide interface comprising a first guide track and a second guide track, wherein the guide interface and the guide tracks, are permanently connected to the chassis.

18. The assembly of claim 17, wherein a first straight line normal to the first track considered in a first plane orthogonal to the direction of uncoupling forms, with the chassis, a first angle comprised between ten and eighty degrees.

19. The assembly of claim 18, wherein a second straight line normal to the second track considered in the first plane forms, with the support, a second angle comprised between ten and eighty degrees.

20. The assembly of claim 17, wherein a first straight line normal to the first track and a second straight line normal to the second track considered in a first plane orthogonal to the direction of uncoupling intersect at a first point.

21. The assembly of claim 20, wherein a third angle formed by the first straight line and the second straight line is comprised between twenty and one hundred and sixty degrees.

22. The assembly of claim 20, wherein the first point belongs to a third straight line substantially parallel to the direction of uncoupling and which passes through a center of gravity of the second element.

23. The assembly of claim 20, wherein the first point is located on an axis of rotation of a rotating shaft of the first element or of the second element.

24. The assembly of claim 17, wherein the guide interface comprises at least one first roller.

25. The assembly of claim 24, wherein the guide interface comprises a first adjusting mechanism for adjusting the position of the first roller relative to the second assembly or the chassis.

26. The assembly of claim 24, wherein the first roller is an eccentric roller.

27. The assembly of claim 17, wherein the guide interface comprises at least one first slide pad.

28. The assembly of claim 17, wherein the guide interface comprises a second adjusting mechanism for adjusting the position of the first slide pad relative to the second assembly or to the chassis.

29. The assembly of claim 28, wherein the guide interface comprises a third adjusting mechanism for adjusting the position of the first track and/or the second track relative to the chassis.

30. The assembly of claim 17, wherein the guide interface is removably connected to the chassis or to the second element.

31. The assembly of claim 17, wherein, with the machine being a rotating machine, the first element is a driven element and the second element is a driving element.

32. A method of assembling or separating the first element and second element of an assembly of claim 17, the method comprising a step of modifying the relative alignment of the first element and second element by adjusting the position of the guide interface along the direction of uncoupling and/or along the normal to the guide track or guide tracks.
